(19) United States
(12) Patent Application Publication
(10) Pub. No.: US 2012/0068972 A1
(43) Pub. Date: Mar. 22, 2012

(54) TOUCH DISPLAY APPARATUS AND OPERATION METHOD THEREOF

(75) Inventors: Chih-Jen Tsang, Hsin-Chu (TW); Yung-Lung Liu, Hsin-Chu (TW); Wei-Cheng Huang, Hsin-Chu (TW)

(73) Assignee: YOUNG LIGHTING TECHNOLOGY CORPORATION, Hsin-Chu (TW)

(21) Appl. No.: 13/231,925

(22) Filed: Sep. 13, 2011

(30) Foreign Application Priority Data
Sep. 21, 2010 (TW) 99132037

(51) Int. Cl. G06F 3/042; G06F 3/041

(52) U.S. Cl. 345/175; 345/173

(57) ABSTRACT

A touch display apparatus including a display unit, a light confinement element, at least one light emitting device, and at least one optical detector is provided. The light confinement element is disposed beside the display unit, and has first and second total internal reflection (TIR) surfaces, and a light incident surface connecting the first and second TIR surfaces. The light emitting device is disposed beside the light incident surface and capable of emitting a light beam which enters the light confinement element through the light incident surface. The first and second TIR surfaces are capable of repeatedly totally reflecting the light beam in the light confinement element, for confining the light beam between the first and second TIR surfaces. When a touch object contacts the first TIR surface, the TIR effect is spoiled, and the touch object reflects a part of the light beam to the optical detector.

### CROSS-REFERENCE TO RELATED APPLICATION

This application claims the priority benefit of Taiwan application serial no. 99132037, filed Sep. 21, 2010. The entirety of the above-mentioned patent application is hereby incorporated by reference herein and made a part of this specification.

### BACKGROUND OF THE INVENTION

1. Field of the Invention

The invention generally relates to a touch apparatus, and more particularly to a touch display apparatus and an operation method thereof.

2. Description of Related Art

With the rapid development of optoelectronic technologies, controlling the operating platform of a computer and objects in the screen by a mouse no longer satisfies a user. Accordingly, an interface more user-friendly than the mouse has been gradually developed. In these user-friendly interfaces, the touch method by using fingers is closest to human experiences in the daily life. In particular, elders and children who may not adroitly operate the mouse can touch with fingers to control easily. This has been partially shown to be true with the touch screen adapted in an automatic teller machine (ATM).

Current touch devices can be generally categorized into resistive, capacitive, optical, sound wave, and electromagnetic designs. A conventional optical touch device is typically disposed around a periphery in front of a display region of a display device, and includes a plurality of light sources, light guide strips, and optical detectors. The light guide strips are disposed on the sides of the display region, whereas the optical detectors are disposed on the corners of the display region. The light emitted from the light sources is guided by the light guide strips, and the light is transmitted towards a sensing space in front of the display region. When the user's finger enters the sensing space, the optical detectors can detect the finger and thereby accomplish touch detection.

However, since a plurality of light guide strips are disposed above the display region of the conventional optical display device, the positioning and the assembly of the light guide strips and the display region are difficult, thereby leading to an increased assembly time. Moreover, the material of the light guide strips and the fixing elements thereof adds to the cost of the optical touch device. In addition, the user's finger is detected by the optical detectors when the finger enters the sensing space but has not touched the display region. Therefore, the operation of the optical touch device is not sufficiently user-friendly, while the command execution is not accurate.

U.S. Patent Application Publication No. 2009/0073142 discloses a light guide plate covering a display panel to serve as a cover, and optical detectors disposed at the sides of the light guide plate to detect the position of the object. Moreover, Taiwan Patent No. M358360 and U.S. Patent Application Publication Nos. 2010/0085330 and 2010/0066704 disclose other touch devices.

### SUMMARY OF THE INVENTION

Accordingly, the invention provides a touch display apparatus that may be easily assembled and has a low cost and a thin overall thickness.

The invention provides an operation method of a touch display apparatus that is convenient and user-friendly.

Other objects and advantages of the invention may be further understood by referring to the technical features broadly embodied and described as follows. In order to achieve one or a part of or all of the aforementioned advantages or other advantages, an embodiment of the invention provides a touch display apparatus including a display unit, a light confinement element, at least one light emitting device, and at least one optical detector. The light confinement element is disposed beside the display unit, and has a first total internal reflection (TIR) surface, a second TIR surface opposite to the first TIR surface, and a light incident surface connecting the first TIR surface and the second TIR surface. The light emitting device is disposed beside the light incident surface and capable of emitting a light beam. The light beam is capable of entering the light confinement element through the light incident surface, and the first TIR surface and the second TIR surface are capable of repeatedly totally reflecting the light beam in the light confinement element, so as to confine the light beam between the first TIR surface and the second TIR surface. The optical detector is disposed beside the light confinement element. A TIR effect of the first TIR surface to the light beam is spoiled, so that a part of the light beam passes through the first TIR surface, and a touch object reflects a part of the light beam to the optical detector when the touch object contacts the first TIR surface.

According to another embodiment of the invention, an operation method of a touch display apparatus including the following steps is provided. The afore-described touch display apparatus is provided. Moreover, at least one touch object is employed to contact the light confinement element of the touch display apparatus so that a TIR effect of the first TIR surface to the light beam is spoiled, and a part of the light beam passes through the first TIR surface. In addition, the touch object is employed to reflect a part of the light beam to the optical detector. The optical detector detects a touch motion of the touch object when a part of the light beam is reflected to the optical detector.

In summary, the embodiments of the invention include at least one of the following advantages. The touch display apparatus according to an embodiment of the invention detects the touch motion by employing the light confinement element coordinated with the principle of spoiling the TIR effect. Since the positioning between the light confinement element and the display unit is simple and the positioning does not place a high demand on accuracy, the assembling of the touch display apparatus according to the embodiment in the invention is easier. Moreover, since a light emitting module above the display unit that is formed by a plurality of light guide strips is not required, the overall thickness of the touch display apparatus in the embodiment of the invention is thin, and the cost may be reduced by saving the usage of materials. In addition, in the operation method of the touch display apparatus according to an embodiment of the invention, the touch display apparatus detects the touch motion when the touch object contacts the light confinement element. Accordingly, the operation method is more convenient and user-friendly compared to the operation method of the conventional optical touch device.

Other objectives, features and advantages of the invention will be further understood from the further technological features disclosed by the embodiments of the invention wherein there are shown and described preferred embodiments of this invention, simply by way of illustration of modes best suited to carry out the invention.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1A is a cross-sectional schematic view of a touch display apparatus according to an embodiment of the invention.

FIG. 1B is a top view of the touch display apparatus depicted in FIG. 1A.

FIG. 2 is a cross-sectional schematic view of a touch display apparatus according to another embodiment of the invention.

FIG. 3 is a cross-sectional schematic view of a touch display apparatus according to yet another embodiment of the invention.

FIG. 4 is a flow chart illustrating the steps of an operation method of a touch display apparatus according to an embodiment of the invention.

### DESCRIPTION OF EMBODIMENTS

In the following detailed description of the preferred embodiments, reference is made to the accompanying drawings which form a part hereof, and in which are shown by way of illustration specific embodiments in which the invention may be practiced. In this regard, directional terminology, such as “top,” “bottom,” “front,” “back,” etc., is used with reference to the orientation of the Figure(s) being described. The components of the invention can be positioned in a number of different orientations. As such, the directional terminology is used for purposes of illustration and is in no way limiting. On the other hand, the drawings are only schematic and the sizes of components may be exaggerated for clarity. It is to be understood that other embodiments may be utilized and structural changes may be made without departing from the scope of the invention. Also, it is to be understood that the phraseology and terminology used herein are for the purpose of description and should not be regarded as limiting. The use of “including,” “comprising,” or “having” and variations thereof herein is meant to encompass the items listed thereafter and equivalents thereof as well as additional items. Unless limited otherwise, the terms “connected,” “coupled,” and “mounted” and variations thereof herein are used broadly and encompass direct and indirect connections, couplings, and mountings. Similarly, the terms “facing,” “faces” and variations thereof herein are used broadly and encompass direct and indirect facing, and “adjacent to” and variations thereof herein are used broadly and encompass directly and indirectly “adjacent to”. Therefore, the description of “A” component facing “B” component herein may contain the situations that “A” component directly faces “B” component or one or more additional components are between “A” component and “B” component. Also, the description of “A” component “adjacent to” “B” component herein may contain the situations that “A” component is directly “adjacent to” “B” component or one or more additional components are between “A” component and “B” component. Accordingly, the drawings and descriptions will be regarded as illustrative in nature and not as restrictive.

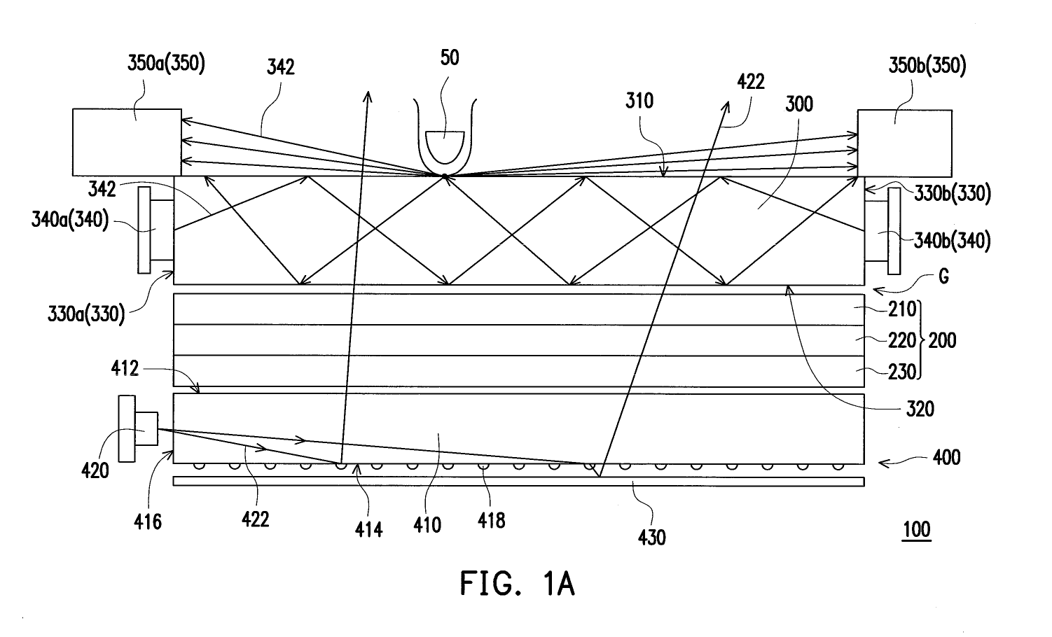

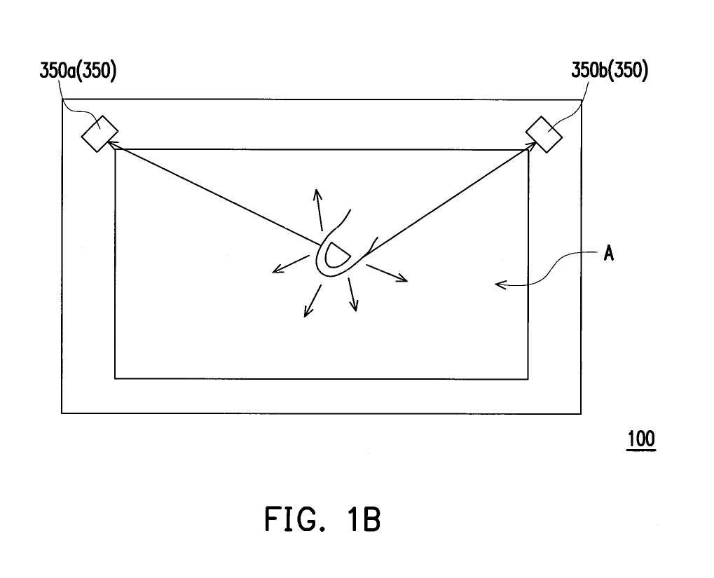

FIG. 1A is a cross-sectional schematic view of a touch display apparatus according to an embodiment of the invention, and FIG. 1B is a top view of the touch display apparatus depicted in FIG. 1A. Referring to FIGS. 1A and 1B, a touch display apparatus 100 in the embodiment includes a display unit 200, a light confinement element 300, at least one light emitting device 340 (e.g., two light emitting devices 340a and 340b depicted in FIG. 1A), and at least one optical detector 350 (e.g., two optical detectors 350a and 350b depicted in FIGS. 1A and 1B). The display unit 200 is, for example, a liquid crystal display panel including an active device matrix substrate 230, a liquid crystal layer 220, and an opposite substrate 210. The liquid crystal layer 220 is disposed between the active device matrix substrate 230 and the opposite substrate 210. The active device array substrate 230 is, for example, a thin film transistor array substrate, whereas the opposite substrate 210 is, for example, a color filter array substrate. However, in other embodiments, the display unit 200 may also be a light emitting diode (LED) array panel, an organic light emitting diode (OLED) array panel, a plasma display panel (PDP), or a cathode ray tube (CRT).

The light confinement element 300 is disposed beside the display unit 200, and has a first total internal reflection (TIR) surface 310, a second TIR surface 320 opposite to the first TIR surface 310, and at least one light incident surface 330 (e.g., two light incident surfaces 330a and 330b depicted in FIG. 1A) connecting the first TIR surface 310 and the second TIR surface 320. In the embodiment, the light confinement element 300 is, for example, a transparent protective layer for protecting the display unit 200. In the embodiment, a Mohs hardness of the light confinement element 300 may be greater or equal to 5H. In an embodiment, the Mohs hardness of the light confinement element 300 may be greater or equal to 6H to provide sufficient hardness to protect the display unit 200, and to prevent the display unit 200 from being scratched by sharp objects. In other embodiments, optical coatings or optical films such as antireflection layers, antiglare layers, or hard coatings may be disposed on the first TIR surface 310 or the second TIR surface of the light confinement element 300.

The light emitting devices 340 are disposed beside the light incident surface 330 and capable of emitting a light beam 342. In the embodiment, the light emitting devices 340 are, for example, infrared LEDs or infrared laser diodes, and the light beam 342 is, for example, an infrared light beam. However, in other embodiments, the light emitting devices 340 may also be other non-visible light emitting devices or visible light emitting devices.

The light beam 342 is capable of entering the light confinement element 300 through the light incident surface 330, and the first TIR surface 310 and the second TIR surface 320 are capable of repeatedly totally reflecting the light beam 342 in the light confinement element 300, so as to confine the light beam 342 between the first TIR surface 310 and the second TIR surface 320. In the embodiment, a roughness average (RA) of the first TIR surface 310 and a roughness average (RA) of the second TIR surface 320 are less than or equal to 50 nm, so that a surface having such roughness average is sufficiently smooth to form a TIR surface. In an embodiment of the invention, the roughness average of the first TIR surface 310 and the second TIR surface 320 is smaller or equal to 20 nm, so as to achieve a preferable TIR effect.

In the embodiment, an air gap G exists between the light confinement element 300 and the display unit 200. However, in other embodiments, the light confinement element 300 and the display unit 200 are jointed to each other, for example by an adhesive. Moreover, the adhesive replaces the air gap between the light confinement element 300 and the display unit 200, so no air gap exists therebetween.

The optical detectors 350 are disposed beside the light confinement element 300. In the embodiment, the light detectors 350 are, for example, charge coupled devices (CCDs), complementary metal-oxide-semiconductor sensors (CMOS sensors), photomultiplier tubes (PMTs), or other optical detectors. In the embodiment, the touch display apparatus 100 has a display region A (as shown in FIG. 1B), in which the display region A is the region used by the touch display apparatus 100 to display an image frame. Moreover, in the embodiment, the optical detectors 350 are disposed above the optical confinement element 300, and the optical detectors 350 are disposed beside the display region A. In the embodiment, the optical detectors 350a and 350b are respectively disposed beside two corners of the display region A. However, in other embodiments, the optical detectors 350 may also be disposed on the edges of the display region A, and the invention is not limited thereto.

When a touch object 50 (e.g., a user's finger or a tip of a stylus) contacts the first TIR surface 310, a TIR effect of the first TIR surface 310 to the light beam 342 is spoiled. The TIR effect is spoiled when the touch object 50 contacts the first TIR surface 310 because the first TIR surface 310 is no longer an interface between the light confinement element 300 and air, but an interface between the light confinement element 300 and the touch object 50. Since a refractive index of the touch object 50 is different from the refractive index of air, a TIR condition originally produced by air and the light confinement element 300 is altered, such that the touched part of the first TIR surface 310 does not generate the TIR effect. Accordingly, a part of the light beam 342 passes through the first TIR surface 310, the touch object 50 is capable of reflecting a part of the light beam 342 to the optical detectors 350, and the optical detectors 350 are capable of detecting the light beam 342.

In the embodiment, the touch display apparatus 100 further includes a visible backlight module 400 capable of providing an illumination beam 422, in which the display unit 200 is disposed between the visible backlight module 400 and the light confinement element 300. Moreover, the illumination beam 422 is capable of passing through the display unit 200 and the light confinement element 300, and carrying the display image of the display unit 200. In the embodiment, the visible backlight module 400 is, for example, a side type backlight module, and includes a light guide plate 410, at least one light emitting device 420, and a reflector 430. The light guide plate 410 has a surface 412, a surface 414 opposite to the surface 412, and a light incident surface 416 connecting the surface 412 and the surface 414. The light emitting device 420 is, for example, a visible LED or other visible light emitting devices emitting the illumination beam 422, in which the illumination beam 422 is a visible light. The illumination beam 422 from the light emitting device 420 is capable of entering the light guide plate 410 through the light incident surface 416. After the illumination beam 422 is transmitted to a light scattering structure 418 of the surface (e.g., the surface 414 depicted in FIG. 1A) of the light guide plate 410, the illumination beam 422 is scattered to the surface 412 and transmitted to the display unit 200 by passing through the surface 412. Alternatively, the illumination beam 422 is scattered by the light scattering structure 418 to the reflector 430 at one side of the surface 414. The reflector 430 is capable of reflecting the illumination beam 422 so the illumination beam 422 is transmitted to the display unit 200 by passing through the surface 414 and the surface 412 in sequence.

When the display unit 200 is an LED array panel, an OLED array panel, a PDP, or a CRT, then the touch display apparatus may omit the visible backlight module 400.

The touch display apparatus 100 of the embodiment detects a touch motion by employing the light confinement element 300 coordinated with the principle of spoiling the TIR effect. Since the positioning between the light confinement element 300 and the display unit 200 is simple and the positioning does not place a high demand on accuracy, the assembling of the touch display apparatus 100 in the embodiment is easier, thereby decreasing the assembly time. Moreover, it is not required to dispose a light emitting module above the display unit 200 that is formed by a plurality of light guide strips. Therefore, an overall thickness of the touch display apparatus 100 in the embodiment is thin, and a cost may be reduced by saving the material for the light guide strips and the fixing elements thereof. In addition, in the touch display apparatus 100 of the embodiment, the touch display apparatus 100 detects the touch motion when the touch object 50 contacts the light confinement element 300. Moreover, when the touch object 50 is suspended above the light confinement element 300, since the TIR effect of the light confinement element 300 is not spoiled, the light beam 342 does not pass through the first TIR surface 310 to be detected by the optical detectors 350, and at this time the touch display apparatus 100 does not sense the touch motion. In conventional optical touch devices, even when the touch object has not touched the surface of the display region, the touch object is detected by the optical detectors when the touch object enters the sensing space in front of the display region, so as to serve as the determination of the touch motion. Accordingly, when using the conventional optical touch devices, the user cannot shift the touch object near the surface of the display region, but the user must be sure about the touch location before approaching the touch object near the display region. This operation method is not user-friendly and is not conducive to successive rapid operations. In comparison, the user of the touch display apparatus 100 in the embodiment may freely move the touch object near the light confinement element 300. When the user wants to make a certain touch command, then the user makes the touch object contact the light confinement element 300 to complete the touch command. Therefore, the touch display apparatus 100 in the embodiment may have a more user-friendly operation method that is suitable for successive rapid operations. Moreover, the execution of the touch command is more accurate and convenient.

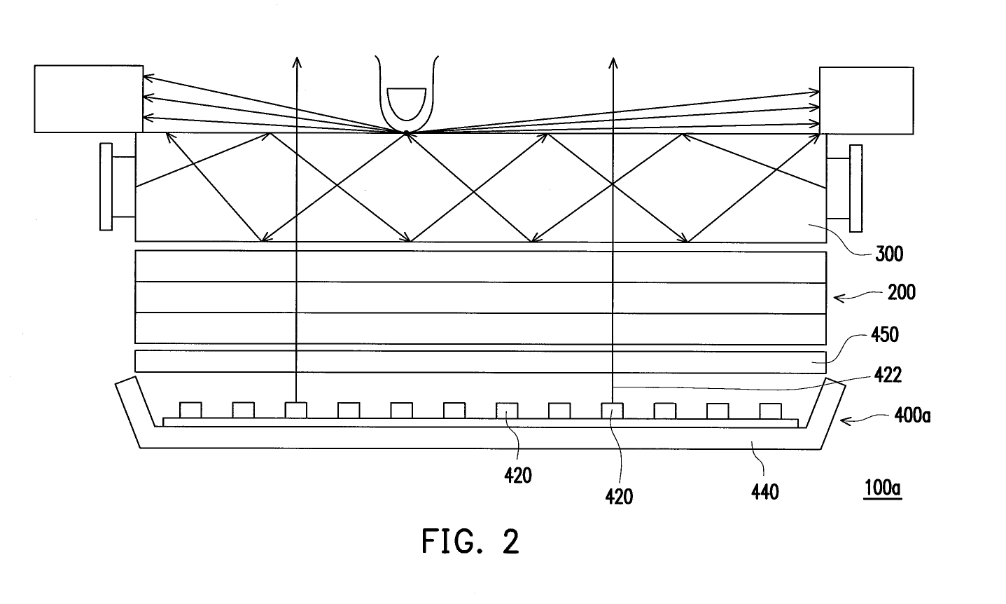

FIG. 2 is a cross-sectional schematic view of a touch display apparatus according to another embodiment of the invention. Referring to FIG. 2, a touch display apparatus 100a of the embodiment is similar to the touch display apparatus 100 depicted in FIG. 1A, and a difference therebetween is described as below. A visible backlight module 400a of the touch display apparatus 100a in the embodiment is a direct type backlight module, and the visible backlight module 400a includes a plurality of light emitting devices 420, a light box 440, and a diffusion plate 450. The light emitting devices 420 are disposed in the light box 440, and after an illumination beam 422 emitted by the light emitting devices 420 is diffused by the diffusion plate 450, the illumination beam 422 is more uniformly transmitted to the display unit 200.

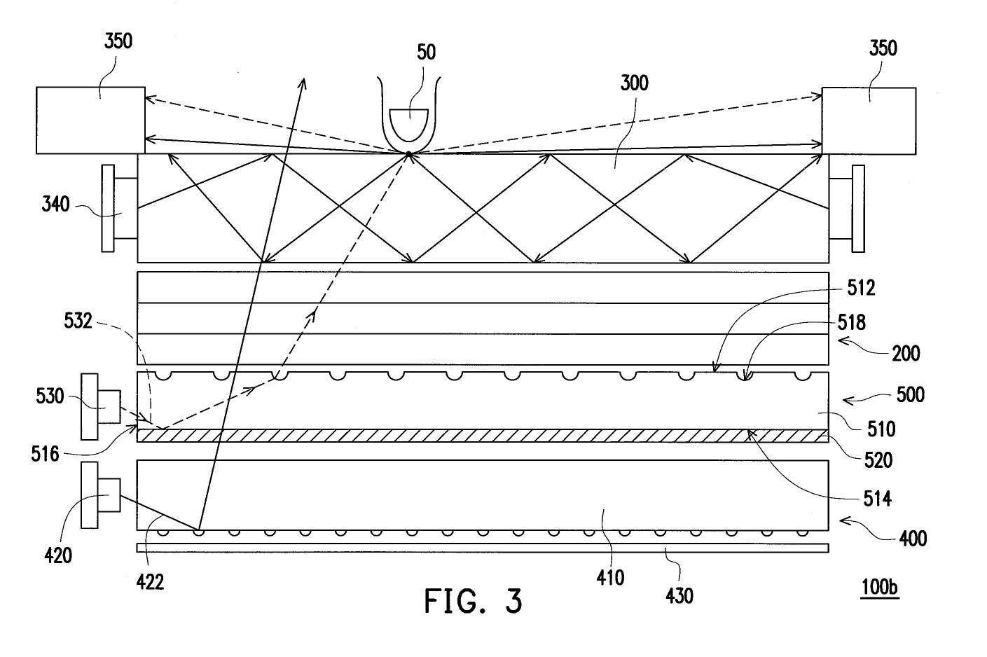

FIG. 3 is a cross-sectional schematic view of a touch display apparatus according to yet another embodiment of the invention. Referring to FIG. 3, a touch display apparatus 100b of the embodiment is similar to the touch display apparatus 100 depicted in FIG. 1A, and a difference therebetween is described as below. In the embodiment, the touch display apparatus 100b further includes a non-visible backlight module 500 disposed between the display unit 200 and the visible backlight module 400, and capable of providing a non-visible light beam 532 (e.g, an infrared light beam or non-visible light beams of other wavelengths). The non-visible light beam 532 is capable of passing through the display unit 200 and the light confinement element 300, and the non-visible light beam 532 is capable of being reflected by the touch object 50 to the optical detectors 350, so that the optical detectors 350 sense the touch object 50. After the non-visible backlight module 500 is coordinated with the light emitting devices 340, an intensity of the infrared light beam is increased, thereby enhancing an identification capability of the optical detectors 350. Moreover, the visible light beam 422 is capable of passing through the non-visible backlight module 500, the display unit 200, and the light confinement element 300, and carrying the display image provided by the display unit 200.

In the embodiment, the non-visible backlight module 500 includes a light guide plate 510, a dichroic unit 520, and at least one non-visible light emitting device 530. The light guide plate 510 has a surface 512, a surface 514 opposite to the surface 512, and a light incident surface 516 connecting the surface 512 and the surface 514. The non-visible light emitting device 530 is, for example, an infrared LED, an infrared laser LED, or other non-visible light emitting devices, and the non-visible light emitting device 530 is disposed beside the light incident surface 516. The non-visible light emitting device 530 is capable of emitting a non-visible light beam 532, and the non-visible light beam 532 is capable of entering the light guide plate 510 through the light incident surface 516. The dichroic unit 520 is, for example, a dichroic film disposed on the surface 514. The dichroic unit 520 is capable of reflecting the non-visible light beam 532 (e.g., an infrared light beam) and allows the visible beam 422 to pass through. When the non-visible light beam 532 in the light guide plate 510 is transmitted to an optical microstructure 518 on the surface (e.g., the surface 512 depicted in FIG. 3) of the light guide plate 510, the non-visible light beam 532 is capable of passing through the surface of the light guide plate 510 and being transmitted to the display unit 200.

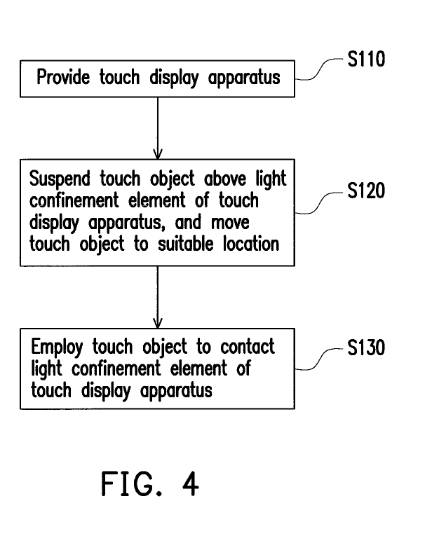

FIG. 4 is a flow chart illustrating the steps of an operation method of a touch display apparatus according to an embodiment of the invention. Referring to FIGS. 1A and 4, an operation method of the embodiment may operate the touch display apparatus 100 of FIG. 1A or the touch display apparatus 100a of FIG. 2. The touch display apparatus 100 of FIG. 1A is used as an example for illustration hereafter, and the operation method of the touch display apparatus 100a of FIG. 2 follows by analogy. The operation method of the touch display apparatus according to the embodiment includes the following steps. First, a Step S110 is executed, in which a touch display apparatus is provided. In the embodiment, the touch display apparatus 100 is provided. Next, a Step S120 is executed, in which the touch object 50 (e.g., the user's finger or the tip of a stylus) is suspended above the light confinement element 300 of the touch display apparatus 100, and the touch object 50 is moved to a suitable position. For example, the user may shift the touch object 50 at a distance near the light confinement element 300 but not yet contacting the light confinement element 300, so as to move the touch object 50 to the suitable position. Thereafter, a Step S130 is executed, in which after the touch object 50 is moved to the suitable position, the touch object 50 is contacted with the light confinement element 300 of the touch display apparatus 100. Thereby, the TIR effect of the first TIR surface 310 to the light beam 342 is spoiled, and a part of the light beam 342 passes through the first TIR surface 310. Moreover, the touch object 50 is used to reflect a part of the light beam 342 to the optical detectors 350. When a part of the light beam 342 is reflected to the optical detectors 350, the optical detectors 350 detect the touch motion of the touch object, thereby completing a single touch detection. It should be noted that the number of the touch object 50 is not limited in the invention. Although the embodiment uses a single touch object 50 as an example, in other embodiments, a plurality of touch objects 50 may be adopted to simultaneously or not simultaneously contact the light confinement element 300, so as to produce single point or multi-point touch.

Moreover, after executing the Step S110, the operation method of the touch display apparatus in the embodiment may include skipping over the Step S120 and directly executing a Step S130. In other words, after the user is sure about the touch location, the touch object 50 is directly contacted with the light confinement element 300, and the touch object 50 is not suspended above the light confinement element 300 to be shifted or freely moved.

In the operation method of the touch display apparatus 100 in the embodiment, the touch display apparatus 100 detects the touch motion when the touch object 50 contacts the light confinement element 300. Moreover, when the touch object 50 is suspended above the light confinement element 300, since the TIR effect of the light confinement element 300 is not spoiled, the light beam 342 does not pass through the first TIR surface 310 to be detected by the optical detectors 350, and at this time the touch display apparatus 100 does not sense the touch motion. In an operation method of a conventional optical touch device, even when the touch object has not touched the surface of the display region, the touch object is detected by the optical detectors when the touch object enters the sensing space in front of the display region, so as to serve as the determination of the touch motion. Accordingly, when using the conventional optical touch devices, the user cannot shift the touch object near the surface of the display region, but the user must be sure about the touch location before approaching the touch object near the display region. This operation method is not user-friendly and is not conducive to successive rapid operations. In comparison, the user of the touch display apparatus 100 in the embodiment may freely move the touch object near the light confinement element 300. When the user wants to make a certain touch command, then the user makes the touch object contacts the light confinement element 300 to complete the touch command. Therefore, the touch display apparatus 100 in the embodiment may have a more user-friendly operation method that is suitable for successive rapid operations. Moreover, the execution of the touch command is more accurate and convenient.

In view of the foregoing, the embodiments of the present invention include at least one of the following advantages. The touch display apparatus according to an embodiment of the invention detects a touch motion by employing the light confinement element coordinated with the principle of spoiling the TIR effect. Since the positioning between the light confinement element and the display unit is simple and the positioning does not place a high demand on accuracy, the assembling of the touch display apparatus according to the embodiment in the invention is easier. Moreover, since a light emitting module above the display unit that is formed by a plurality of light guide strips is not required, the overall thickness of the touch display apparatus in the embodiment of the invention is thin, and the cost may be reduced by saving the usage of materials. In addition, in the operation method of the touch display apparatus according to an embodiment of the invention, the touch display apparatus detects the touch motion when the touch object contacts the light confinement element. Accordingly, the operation method is more convenient and user-friendly compared to the operation method of the conventional optical touch device.

The foregoing description of the preferred embodiments of the invention has been presented for purposes of illustration and description. It is not intended to be exhaustive or to limit the invention to the precise form or to exemplary embodiments disclosed. Accordingly, the foregoing description should be regarded as illustrative rather than restrictive. Obviously, many modifications and variations will be apparent to practitioners skilled in this art. The embodiments are chosen and described in order to best explain the principles of the invention and its best mode practical application, thereby to enable persons skilled in the art to understand the invention for various embodiments and with various modifications as are suited to the particular use or implementation contemplated. It is intended that the scope of the invention be defined by the claims appended hereto and their equivalents in which all terms are meant in their broadest reasonable sense unless otherwise indicated. Therefore, the term “the invention”, “the present invention” or the like does not necessarily limit the claim scope to a specific embodiment, and the reference to particularly preferred exemplary embodiments of the invention does not imply a limitation on the invention, and no such limitation is to be inferred. The invention is limited only by the spirit and scope of the appended claims. Moreover, these claims may refer to use “first”, “second”, etc. following with noun or element. Such terms should be understood as a nomenclature and should not be construed as giving the limitation on the number of the elements modified by such nomenclature unless specific number has been given. The abstract of the disclosure is provided to comply with the rules requiring an abstract, which will allow a searcher to quickly ascertain the subject matter of the technical disclosure of any patent issued from this disclosure. It is submitted with the understanding that it will not be used to interpret or limit the scope or meaning of the claims. Any advantages and benefits described may not apply to all embodiments of the invention. It should be appreciated that variations may be made in the embodiments described by persons skilled in the art without departing from the scope of the present invention as defined by the following claims. Moreover, no element and component in the present disclosure is intended to be dedicated to the public regardless of whether the element or component is explicitly recited in the following claims.

What is claimed is:

1. A touch display apparatus, comprising:
a display unit;
a light confinement element disposed beside the display unit, having a first total internal reflection surface, a second total internal reflection surface opposite to the first total internal reflection surface, and a light incident surface connecting the first total internal reflection surface and the second total internal reflection surface;
at least one light emitting device disposed beside the light incident surface, capable of emitting a light beam, wherein the light beam is capable of entering the light confinement element through the light incident surface, and the first total internal reflection surface and the second total internal reflection surface are capable of repeatedly totally reflecting the light beam in the light confinement element, so as to confine the light beam between the first total internal reflection surface and the second total internal reflection surface; and
at least one optical detector disposed beside the light confinement element, wherein a total internal reflection effect of the first total internal reflection surface to the light beam is spoiled so that a part of the light beam passes through the first total internal reflection surface, and a touch object reflects a part of the light beam to the optical detector when the touch object contacts the first total internal reflection surface.

2. The touch display apparatus as claimed in claim 1, wherein a roughness average of the first total internal reflection surface and a roughness average of the second total internal reflection surface are less than or equal to 50 nm.

3. The touch display apparatus as claimed in claim 1, wherein the light confinement element is a transparent protective layer for protecting the display unit.

4. The touch display apparatus as claimed in claim 1, wherein a Mohs hardness of the light confinement element is greater or equal to 5H.

5. The touch display apparatus as claimed in claim 1, wherein an air gap exists between the light confinement element and the display unit.

6. The touch display apparatus as claimed in claim 1, wherein the light confinement element and the display unit are jointed to each other, and no air gap exists between the light confinement element and the display unit.

7. The touch display apparatus as claimed in claim 1, wherein the display unit is a liquid crystal display panel, a light emitting diode array panel, an organic light emitting diode array panel, a plasma display panel, or a cathode ray tube.

8. The touch display apparatus as claimed in claim 1, wherein the touch display apparatus has a display region, and the optical detector is disposed beside the display region.

9. The touch display apparatus as claimed in claim 1, wherein the light emitting device is an infrared light source.

10. The touch display apparatus as claimed in claim 1, further comprising a visible backlight module capable of providing an illumination beam, wherein the display unit is disposed between the visible backlight module and the light confinement element, and the illumination beam is capable of passing through the display unit and the light confinement element.

11. The touch display apparatus as claimed in claim 10, further comprising a non-visible backlight module disposed between the display unit and the visible backlight module, and the non-visible backlight module capable of providing a non-visible light beam, wherein the non-visible light beam is capable of passing through the display unit and the light confinement element and being reflected by the touch object to the optical detector, and the visible light beam is capable of passing through the non-visible backlight module, the display unit, and the light confinement element.

12. The touch display apparatus as claimed in claim 11, wherein the non-visible backlight module comprises a light guide plate, a dichroic unit, and at least one non-visible light emitting device.

13. The touch display apparatus as claimed in claim 12, wherein the light guide plate has a first surface, a second surface opposite to the first surface, a third surface connecting the first surface and the second surface, the non-visible light emitting device is disposed beside the third surface, and the dichroic unit is disposed on the first surface.

14. The touch display apparatus as claimed in claim 11, wherein the dichroic unit is capable of reflecting the non-visible light beam and allows the visible beam pass through.

15. The touch display apparatus as claimed in claim 1, wherein an optical coating is disposed on the first total internal reflection surface or the second total internal reflection surface.

16. An operation method of a touch display apparatus, comprising:
providing the touch display apparatus of claim 1; and
employing at least one touch object to contact the light confinement element of the touch display apparatus so that a total internal reflection effect of the first total internal reflection surface to the light beam is spoiled, and a part of the light beam passes through the first total internal reflection surface, and employing the touch object to reflect a part of the light beam to the optical detector, wherein the optical detector detects a touch motion of the touch object when a part of the light beam is reflected to the optical detector.

17. The operation method as claimed in claim 16, further comprising:
suspending the touch object above the light confinement element, moving the touch object to a suitable location, and contacting the touch object with the light confinement element so as to complete the touch motion.
